(19) United States
(12) Patent Application Publication
(10) Pub. No.: US 2022/0145961 A1
(43) Pub. Date: May 12, 2022

(54) Connection And Connector And Device For A Belt Connection

(71) Applicant: MATO GmbH & Co. KG, Mühlheim am Main (DE)

(72) Inventors: Michael Frieß, Hanau (DE); Thomas Wilk, Mühlheim (DE)

(73) Assignee: MATO GmbH & Co. KG, Mühlheim am Main (DE)

(21) Appl. No.: 17/522,638

(22) Filed: Nov. 9, 2021

(30) Foreign Application Priority Data
Nov. 10, 2020 (EP) 20 206 706.2

(51) Int. Cl. F16G 3/08; F16G 3/16

(52) U.S. Cl. CPC F16G 3/08; F16G 3/16

(57) ABSTRACT

A connection of two ends of a belt, or an end of a belt and an end of a further belt, wherein a first end has a first connecting portion and a second end has a second connecting portion, wherein the first and second connecting portions are arranged to overlap in an overlapping region, wherein a plurality of connectors are arranged in the overlapping region, wherein each connector penetrates the first and second connecting portions, wherein each connector has a first base body portion and a second base body portion, wherein the first and second connecting portions are arranged between the first and second base body portions, wherein each connector has at least two connecting means held in the first and second base body portions that penetrate the first and second connecting portions. A connector for producing a connection and a device for producing a connection are also provided.

### FIELD OF THE INVENTION

The present invention relates to a connection of two ends of a belt, in particular a conveyor belt, or a connection of one end of a belt and one end of a further belt. The two belts may be conveyor belts, for example. The invention further relates to a connector for producing such a connection and a device for producing such a connection. The connection serves, in particular, for connecting the ends of a belt or a plurality of belts such that an endless belt is formed.

### BACKGROUND OF THE INVENTION AND RELATED ART

A known connection of ends of a belt or belts is carried out by means of a stepped connection, wherein to this end the band ends have stepped connecting portions corresponding to one another or accordingly corresponding stepped connecting portions are introduced, said connecting portions being arranged so as to overlap, wherein in the overlapping region of the two connecting portions a material connection is produced between the two connecting portions, for example by means of vulcanization or by means of adhesive bonding, so that the two connecting portions and thus the band ends are subsequently connected together by a material connection. A drawback with a material connection of the two connecting portions is that the two connecting portions have to have a very large contact surface, for example a very large extent in the longitudinal direction of the belt, in order to ensure sufficient tensile strength. Additionally, the production of a sufficiently tension-resistant material connection is very time-consuming. Thus in order to ensure sufficient tensile strength, the work has to be carried out very carefully. In particular, when producing the connecting portions as well as when applying the adhesive and/or during vulcanization, the work has to be carried out very carefully in order to achieve a sufficiently tension-resistant connection. For example, the work has to be carried out in very clean conditions in order to avoid contamination of the connecting surfaces, which would have a negative impact on the stability of the connection. This is difficult, in particular, when poorly trained personnel, laypersons or end users, for example a farmer, carries out or, respectively, has to carry out the connection of the belt ends, for example in the context of replacing the belt of a machine or repairing the belt.

A V-belt with a stepped connection is disclosed in DE 741 665 A, wherein additional rivets or stud pins are provided.

A belt as a tension means for band conveyors of agricultural machines is disclosed in DE 10 2011 116 633 A1, the ends thereof having an upper step or, respectively, a lower step which bear against one another in an overlapping region and which are connected together in a tension-resistant manner by a screw connection, riveting or post-vulcanization.

### Objects of the Invention

It is the object of the present invention to provide a connection of two ends of a belt or one end of a belt and one end of a further belt, which may be produced in a particularly simple manner and is characterized by a particularly high transmission of force, but with a relatively small overlapping region in the direction of travel of the belt and a particularly long durability. It is also the object of the invention to provide a connector for producing such a connection. Moreover, it is an object of the invention to provide a device which is suitable for producing such a connection.

These objects are achieved by a connection, a connector and a device according to the present invention as described herein and shown in the accompany drawing figures.

### SUMMARY OF THE INVENTION

The connection according to the invention is a connection of two ends of a belt, in particular a conveyor belt, or one end of a belt and one end of a further belt, in particular the ends of two conveyor belts. The belt or, respectively, the belts are, in particular, a multilayered belt or, respectively, multilayered belts. The connection according to the invention is used, in particular, in conveyor belts and belts of agricultural machines, for example a baling press belt.

The connection serves, in particular, for connecting one end of a belt to a further end of the same belt. It is, however, also conceivable to connect the end of one belt to the end of a further belt by means of the connection.

A first end of the two ends has a stepped and/or wedge-shaped first connecting portion and a second end of the two ends has a stepped and/or wedge-shaped second connecting portion corresponding in configuration to the first connecting portion. It is conceivable that the connecting portions have further structures corresponding to one another, for example undulating structures and/or toothings and/or one or more oblique cuts. The two connecting portions are arranged so as to overlap in an overlapping region. According to the invention it is provided that a plurality of connectors are arranged in the overlapping region, wherein the respective connector penetrates the first connecting portion and the second connecting portion. The respective connector has a first base body portion and a second base body portion. The two connecting portions in this case are arranged between the two base body portions, wherein the respective connector has at least two connecting means, wherein the at least two connecting means are held in the first and the second base body portion and penetrate the first and the second connecting portion.

In the present case the term belt is understood to mean, in particular, a conveyor belt. However, the belt may also be a band, in particular, a band conveyor.

The belt is, in particular, a multilayered belt, in particular a multilayered conveyor belt. The multilayered belt may have an upper top layer and a lower top layer and at least one intermediate layer configured between the top layers. The at least one intermediate layer, for example, may be a carcass, an intermediate rubber layer, an intermediate tensile force carrier, a textile, a skim layer and/or a fabric, in particular a fabric with polyester for the warp threads and polyamide, also known by the trade name Nylon, for the weft threads, an EP fabric, an EPP fabric, a PEP fabric or a fabric made of polyester and polyamide inserts. The upper and/or lower top layer consists, in particular, of a resilient material or comprises such a resilient material. The upper and/or lower top layer consists, in particular, of a non-vulcanized rubber or comprises non-vulcanized rubber.

The connecting portions are designed, in particular, such that in the overlapping region the tensile force carrier bears against the tensile force carrier and/or the fabric bears against the fabric and/or the carcass bears against the carcass.

It is regarded as particularly advantageous if the abutting ends of the connecting portions are configured obliquely, in particular as oblique cuts. The result of the oblique abutment is that the connection of the belt/the belts is not simultaneously stressed over the entire belt width when deflected on drums and/or rollers. The greater the angle of inclination, the lower the proportion of abutting ends which are stressed during the deflection and the greater the total length of the respective abutting end. An angle of inclination in the present case is understood to mean the angle which is enclosed by the width direction of the belt and the abutting end. An abutting end which is configured parallel to the width direction of the belt has an angle of inclination of 0°. The dimension of the abutting end would be minimal in the case of an angle of inclination of 0°. Preferably the angle of inclination has a value of 10° to 70°, preferably of 10° to 18°. However, it is also conceivable and preferred that the angle of inclination has a value of 40° to 50°, in particular of 45°. Such an angle of inclination may be produced in a particularly simple manner. For example, a right-angled isosceles triangle may be defined, the length of the sides in each case corresponding to the width of the belt. The oblique cut is then made along the hypotenuse.

In particular in the case of small drum/roller diameters, V-shaped or multiple V-shaped abutting ends are also conceivable.

By using a plurality of connectors which in each case have a plurality of connecting means, a particularly high force transmission may be achieved but with a small overlapping region of the two ends in the direction of travel of the belt. It has also been shown that such a connection has a particularly long service life, even in the case of significant mechanical loading.

As the respective connector has a first base body portion and a second base body portion, in which in each case the plurality of connecting means which penetrate the connecting portions are mounted, a particularly advantageous force guidance is implemented when introducing a tensile force into the connected belt or, respectively, into the connected belts so that forces occurring in the region of the connection, in particular shear forces, may be particularly effectively absorbed or, respectively, introduced into the belt or, respectively, the belts. As a result, a particularly stable connection is ensured in the region of the two ends.

Due to the use of a plurality of connectors and, in particular, due to the design of the connector with two base body portions, the connection may have a particularly flat construction since the material thickness of the components of the connectors may be particularly small.

Preferably the maximum extent, in this regard a longitudinal extent, of the base body portion, is less than 50% of a width of the belt, whereby a deformation of the belt as takes place, for example, on a pulley is only impaired to a small degree by the connectors, which in turn advantageously has an effect on the durability or, respectively, service life of the connection. Thus the belt remains particularly flexible in such an embodiment, in particular also transversely to the direction of travel. The width in this case is the extent of the belt perpendicular to a direction of travel of the belt and perpendicular to a thickness of the belt, wherein the thickness of the belt is the extent of the belt from one outer surface to the opposing outer surface. Particularly preferably, the longitudinal extent is less than 30% of a width of the belt. In particular, the longitudinal extent is between 10% and 30% of the maximum extent of the belt.

Preferably, the connectors are arranged spaced apart from one another. As a result, in spite of the connectors the belt is stiffened only to a small degree and a deformation of the belt, as takes place for example on a pulley, is only impaired to a small degree by the connectors, which in turn has an advantageous effect on the durability or, respectively, the service life of the connection. Thus in such an embodiment the belt remains particularly flexible, in particular also transversely to the direction of travel. The minimal spacing between two adjacent connectors is preferably at least 10% of the longitudinal extent of the base body portion. Preferably, the minimum spacing between two adjacent connectors is between 10% and 50% of the longitudinal extent of the base body portion of one of the connectors.

Preferably, the two base body portions bear against opposing outer surfaces of the belt.

Regarding the stability of the connection, the two base body portions of the connector are also to be regarded as advantageous such that in contrast to the connecting means and in contrast to conventional rivets or stud pins which are configured to be substantially pin-shaped, the two base body portions have a relatively large extent or, respectively, surface area perpendicular to the thickness of the belt, so that when producing the connection or when using the belt the situation is avoided that the two base body portions or one of the base body portions is forced into the material of the belt such that a top layer forming the outer surface of the belt is damaged, which may have a negative effect on the properties of the belt, in particular when the top layer of the belt serves for corrosion protection and/or protecting goods to be conveyed from contaminants.

It is, however, conceivable and advantageous if at least one of the base body portions, preferably both base body portions, is/are pushed into the belt when the belt is deformed, in particular when the top layer is deformed. As a result, a particularly flat construction is achieved. Additionally the base body portion or, respectively, the base body portions in such an embodiment is/are protected in a particularly effective manner from the external effects of force, in particular from pulleys.

It is also conceivable that the connecting portions, in particular in the region of the top layer, have indentations for receiving the base body portions.

The belt is, in particular, a conveyor belt, in particular a multilayered conveyor belt. Preferably, the conveyor belt is a multilayered conveyor belt for agricultural machines, for example a conveyor belt for a baling press.

It is regarded as particularly advantageous if the connecting means is positively held in at least one of the base body portions. Preferably, the connecting means is positively held in the respective base body portion. It is regarded as advantageous if the connecting means is held by a material deformation of the connecting means, in particular by a closing head, in at least one of the base body portions. The connecting means is configured, in particular, as a pin, rivet or stud pin. Preferably, the connecting means is held by a first material deformation of the connecting means, in particular by a first closing head, in the first base body portion and is held by a second material deformation of the connecting means, in particular by a second closing head, in the second base body portion. Preferably, the first and the second closing heads are configured on opposing ends of the connecting means.

Preferably, the respective material deformation, in particular the respective closing head, is configured on the connecting means during the production of the connection. Accordingly, in such an embodiment, the connecting means of the respective connector do not yet have a material deformation before the production of the connection.

However, it is also conceivable that the connecting means has a thread which is, for example, configured as a screw and at least one, preferably exactly one, of the base body portions has a counter thread corresponding to the thread, wherein the connecting means is screwed into the counter thread of the base body portion.

It is regarded as advantageous if the first base body portion and/or the second base body portion on the side remote from the connecting portions protrudes relative to one respective end of the at least two connecting means or terminates flush therewith. As a result, the situation is avoided that goods or materials transported by the belt act directly on the connecting means, whereby damage to the connecting means is avoided. In this regard, in such a design the connecting means is particularly well protected against external mechanical influences.

It is regarded as particularly advantageous if the belt has a plurality of, thus at least two, layers, in particular the belt is configured as a multilayered conveyor belt. In the case of a plurality of layers a particularly high degree of stability of the connection may be achieved, in particular when one of the layers, preferably an inner layer, in this regard an intermediate layer, is formed by a fabric. Preferably, the connecting means penetrates both an inner layer of the first connecting portion and an inner layer of the second connecting portion. Preferably, the respective inner layer is a fabric.

It is regarded as particularly advantageous in a stepped connecting portion if the stepped connecting portion is configured such that the steps are formed in each case by an exposed layer of the multilayered conveyor belt.

Preferably, in the overlapping region between the connecting portions no material connection is present between the connecting portions. It has been surprisingly shown that the connection according to the invention also has sufficient tensile strength and durability even without a material connection, in particular without adhesive bonding or vulcanization of the connecting portions. Such an embodiment is particularly advantageous when a repair of the belt or a production of the belt connection has to take place in areas which are difficult to access, in particular in areas in which large appliances are not available in a simple manner for adhesive bonding or vulcanization. For the end user, for example a farmer, the production of a connection is also possible in a simpler manner without a material connection since a purely mechanical connection may be produced in a simple manner with the connectors. In particular, the production process may take place substantially independently of drying times and/or the weather conditions.

The connectors are also to be regarded as advantageous in the case of an additional material connection since the loading of the material connection is reduced by the mechanical connectors. Additionally, the connectors provide additional safety in the case of wear or a reduction in the stability of the material connection. This is advantageous, in particular, in that a loss of stability of the material connection is barely identifiable. Even with the loss of the material connection, the belt may continue to be used at least temporarily. It is also conceivable, in the case of a material connection of the belt ends which is beginning to be released, to reinforce the existing connection by introducing connectors in order to avoid a complete release of the connection.

In particular, it is provided that the base body portions have a greater extent in the transverse direction of the belt, thus in the width direction of the belt, than in the longitudinal direction of the belt, wherein the longitudinal direction of the belt is defined by the direction of travel of the belt.

It is regarded as particularly advantageous if the connecting means of a connector are arranged along a straight line, in particular in a main direction of extent, in particular a longitudinal direction of the base body portions.

Preferably, the connecting means are arranged in the longitudinal direction of the base body portions one behind the other.

Preferably, the connector has only a single row of connecting means.

Preferably, the connector has two to ten, preferably two to eight, particularly preferably two to six, connecting means.

In particular, it is provided that the connecting means of a connector are arranged substantially in the transverse direction of the belt or in the transverse direction of the belt, preferably at an angle of 0° to 20° to the transverse direction of the belt. As a result, a deflection of the belt via a pulley is possible since the belt is barely stiffened by the connectors in the longitudinal direction.

For the same reason, it is regarded as advantageous if the connector is arranged such that the main direction of extent of the base body portions are arranged substantially in the transverse direction of the belt or in the transverse direction of the belt, preferably at an angle of 0° to 20° to the transverse direction of the belt.

In a preferred embodiment, it is provided that the connection has at least two rows of connectors, preferably at least two parallel rows of connectors, wherein the respective row has at least two connectors. Preferably, the rows are configured at an angle of 0° to 20° to the transverse direction of the belt.

It is conceivable that the connectors are arranged in a V-shaped manner.

Preferably, the rows are spaced apart in the direction of travel of the belt.

It is conceivable that additionally connectors with just one connecting means are present in the connection.

The connector according to the invention is suitable for producing a connection according to one of the aforementioned aspects. The features of the connector which are described relative to the connection accordingly apply to the connector per se and conversely the features described relative to the connector accordingly apply to the connection per se.

Preferably, the connector has a first base body portion and a second base body portion, wherein the two connecting portions of the ends of the belt or the belts to be connected are able to be arranged so as to overlap between the two base body portions, wherein the connector also has at least two connecting means, wherein the at least two connecting means are mounted in the first base body portion and may be connected to the second base body portion by penetrating the connecting portions which may be arranged between the two base body portions.

In a preferred embodiment of the connector at least one of the base body portions in the region of a peripheral edge has at least two indentations, preferably two opposing indentations relative to the connecting means, for receiving bearing means for bearing the base body portion, in particular for the purpose of positioning and orientating the respective base body portion before connecting the connector to the belt. This is particularly advantageous regarding the production of the connection by means of such a connector. Since for the purpose of producing the connection the connector should preferably be oriented particularly accurately relative to the overlapping region, and in particular the two base body portions should also be oriented particularly accurately opposite one another, such a design simplifies the production of the connection. This is the case, in particular, when the connecting means are configured as rivets or stud pins or screws which have to be driven into at least one of the base body portions. The indentations may be introduced into the bearing means of a device for bearing the base body portion. Due to the bearing means the situation is avoided that when arranging the connecting portions and/or when introducing the connecting means the position or, respectively, the orientation of the base body portion or, respectively, base body portions is inadvertently changed.

The base body portions are preferably of plate-shaped, in particular strip-shaped, configuration. Preferably, the base body portion is a stamped part from sheet metal. In this case it is conceivable that the sheet metal or the stamped part is locally deformed and/or machined, for example as a bore and/or a chamfer for the closing head and/or radially external chamfers are introduced.

Preferably, the respective base body portion has a greater longitudinal extent than a lateral extent. As a result, this promotes a particularly high degree of stability but with a low degree of stiffness of the connection. The lateral extent is preferably less than 50% of the longitudinal extent, preferably between 10% and 50% of the longitudinal extent, particularly preferably between 20% and 40% of the longitudinal extent.

Preferably, the respective base body portion has a material thickness of 1 mm to 2 mm, in particular a material thickness of 1.3 mm to 1.7 mm, particularly preferably a material thickness of 1.5 mm. Preferably, the longitudinal extent of the base body portion is 2 cm to 8 cm.

Preferably, the connecting means has a maximum extent, thus a longitudinal extent, of 1 cm to 4 cm.

Preferably, the connecting means has a material thickness of 1 mm to 3 mm.

Preferably, the connecting means are configured as stud pins in the manner of a solid cylinder with a circular bottom surface. The diameter of the stud pins is, in particular, 1 mm to 3 mm, in particular 1.5 mm to 2.5 mm, particularly preferably 2 mm.

In particular, at least one of the base body portions has a lead-in edge for pulleys. Damage to the connector when the belt is deflected on a pulley is avoided by the preferably wedge-shaped lead-in edge, since the pulley then rolls relatively smoothly over the lead-in edge and thus the base body portion.

It is regarded as particularly advantageous if the respective connecting means is configured in one piece, in particular the respective connecting means, the first base body portion and the second base body portion are configured in each case in one piece.

It is regarded as particularly advantageous if the connector exclusively consists of the first and the second base body portion and the connecting means.

Preferably, the respective connecting means and/or the first base body portion and/or the second base body portion consist of a metal or of a metal alloy.

Preferably, the respective connecting means and/or the first base body portion and/or the second base body portion consist of a steel, in particular a stainless steel.

For the purpose of a particularly advantageous production and a particularly advantageous storage, it is regarded as advantageous if the base body portions are configured as separate parts, in particular the first base body portion, the second base body portion and the connecting means are configured as separate parts.

It is regarded as particularly advantageous if, for the purpose of producing the connection, the first base body portion is already provided with the connecting means and the second base body portion forms a separate part. As a result, the arrangement of the components of the connector relative to the connecting portions is simplified. Preferably, in such an embodiment the connecting means protrude relative to the first base body portion on a side of the first base body portion remote from the second base body portion.

It is regarded as advantageous if the first base body portion has bearing openings, wherein the respective connecting means is mounted non-positively in one of the bearing openings. As a result, the first base body portion and the connecting means may be handled together, whereby the production of the connection is simplified. The connecting means are preferably mounted in a type of interference fit or friction fit in the respective bearing opening of the first base body portion. The advantage of a non-positive connection is that, for the purpose of producing the connection with a sufficient action of axial force on the connecting means, the connecting means may be driven further into the bearing opening in order to produce a connection with the second base body portion.

In an advantageous development it is provided that the second base body portion has receiving openings for receiving the connecting means. It is regarded as advantageous if the receiving openings widen in the direction of the first base body portion, in particular widen conically. As a result, the production of a connection between the first base body portion and the second base body portion is simplified by means of the connecting means, in particular when the connecting means are displaced in the direction of the second base body portion for the purpose of producing the connection, since due to the receiving opening widening in the direction of the first base body portion, a certain guidance is produced for the connecting means.

Preferably the bearing opening or, respectively, the receiving opening penetrates the respective base body portion.

It is conceivable that the receiving opening receives the connecting means with play, whereby an insertion of the connecting means into the receiving opening is simplified, in particular, also in the case of non-accurate positioning or production tolerances.

It is regarded as particularly advantageous if the connecting means has in each case a deformation portion at least at one end, preferably at both ends, for forming a closing head when the respective deformation portion is deformed.

In an advantageous development it is provided that the respective base body portion has a recess, for example in the form of an indentation, in particular in the form of a chamfer, for receiving the respective closing head.

It is conceivable that the respective deformation portion is formed by a material weakening. This material weakening may be, for example, an axial recess. However, it is regarded as particularly advantageous in the sense of a particularly simple and cost-effective production and a high degree of stability if the connecting means does not have a material weakening but is preferably configured as a stud pin in the manner of a solid cylinder with a circular bottom surface. In the case of a sufficiently high action of force, a deformation may be carried out for the purpose of forming a closing head even without a material weakening, in particular even in the case of a solid material.

It is regarded as particularly advantageous if the first base body portion and the second base body portion of a connector are configured identically. As a result, by using the same parts, production costs and inventory storage costs are saved.

It is conceivable that the connecting means on the end side has a receiver for an expanding mandrel for the purpose of forming a closing head. The receiver may be formed by the material weakening of the deformation portion. It is regarded as particularly advantageous, however, in the sense of a particularly simple and cost-effective production and a high degree of stability if the connecting means does not have a receiver, but the connecting means has a planar closed surface on the end side. In the case of a sufficiently high action of force, a deformation may be carried out for the purpose of forming a closing head even without a material weakening, in particular even in the case of a solid material.

The device according to the invention for producing the connection has clamping jaws which are movable relative to one another, wherein a receiving region is configured between the clamping jaws for the clamped receiving of the connecting portions in the overlapping region of the connecting portions. By the mobility of the two clamping jaws to one another, the connecting portions may be secured in a particularly simple manner in their orientation to one another or, respectively, in their arrangement to one another, namely by bringing the clamping jaws toward one another. A first clamping jaw of the two clamping jaws has bearing structures for bearing the second base body portions. The bearing structures may be, for example, bearing means which engage in a corresponding indentation of the respective base body portion or the bearing structures have corresponding bearing means. The device also has a deformation tool for deforming one end of the connecting means. A second clamping jaw of the two clamping jaws has at least one, preferably a plurality of, guide structures penetrating this clamping jaw, for axially guiding the deformation tool. The respective guide structure is configured to receive at least two, preferably exactly two, adjacent connecting means of a connector such that with an axial displacement of the deformation tool in the direction of the first clamping jaw the deformation tool comes into contact with the two connecting means on the end side.

By means of such a device the production of the connection according to the invention is possible in a particularly simple manner. In particular, due to the design of the guide structure and the deformation tool, at least two connecting means are simultaneously driven in a simple manner into the two connecting portions and the opposing base body portion and deformed on the end side, for the purpose of producing the connection. Moreover, the device permits the arrangement of a plurality of connectors, preferably all of the connectors of the connection in one step.

Preferably, the guide structure is formed by a through-opening with a circular cross section.

Preferably, the second clamping jaw of the two clamping jaws has bearing structures for bearing the first base body portions. The bearing structures may be, for example, bearing means which engage in a corresponding indentation of the respective base body portion or the bearing structures have corresponding bearing means.

Preferably, the deformation tool has on the end side a peripheral projection which protrudes in the axial direction and which forms a deformation structure. As a result, the formation of a closing head is simplified. Moreover, the handling is simplified in the case of a peripheral projection, since an accurate rotational orientation of the deformation tool is not required.

The device is advantageous, in particular, when using a connector in which the first base body portion is already provided with the connecting means and the second base body portion forms a separate part.

In a preferred embodiment, the device has a plurality of deformation structures arranged in the first clamping jaw, wherein the deformation structures serve for deforming the connecting means at an end of the connecting means remote from the first clamping jaw. The deformation structures are preferably configured in the manner of a mandrel.

Preferably, the deformation structure of the deformation tool and the deformation structures arranged in the first clamping jaw are designed differently. As a result, the formation of closing heads on the end side is promoted, with at the same time the action of the deformation structures on the opposing ends of the connecting means.

### BRIEF DESCRIPTION OF THE DRAWING FIGURES

The invention is described in more detail with reference to exemplary embodiments shown in the following drawing figures, without being limited thereto.

FIG. 1 shows a connector according to the invention in a state in which a first base body portion and a second base body portion of the connector are connected together by means of connecting means, in a perspective view.

FIG. 2 shows a detail of a belt with a connection according to the invention of belt ends in a perspective view.

FIG. 3 shows the belt according to FIG. 2 in a view in the longitudinal direction of the belt.

FIG. 4 shows the belt according to FIG. 2 in a plan view.

FIG. 5 shows the belt according to FIG. 2 in a view in the transverse direction of the belt.

FIG. 6 shows the belt according to FIG. 2 before producing the connection, in a view in the transverse direction of the belt.

FIG. 7 shows one of the belt ends according to FIG. 6 in a perspective view.

FIG. 8 shows the connector according to FIG. 1 in a state before producing the connection.

FIG. 9 shows a device for producing the connection according to FIG. 2 in a sectional view.

FIG. 10 shows a first clamping jaw of the device according to FIG. 9 in a perspective view.

FIG. 11 shows a partial region of FIG. 9.

### DESCRIPTION OF EXEMPLARY EMBODIMENTS OF THE INVENTION

FIG. 2 shows a connection of two ends 2, 3 of a belt 1, in the present case a multilayer conveyor belt with three tensile-force carriers in the form of textile layers 12, wherein in each case an intermediate layer 28 is configured between the textile layers 12. (See FIG. 6). The intermediate layer 28 may be an intermediate rubber layer, for example. Moreover, the belt 1 has a first outer top layer 27 and a second outer top layer 27 opposing the first outer top layer 27.

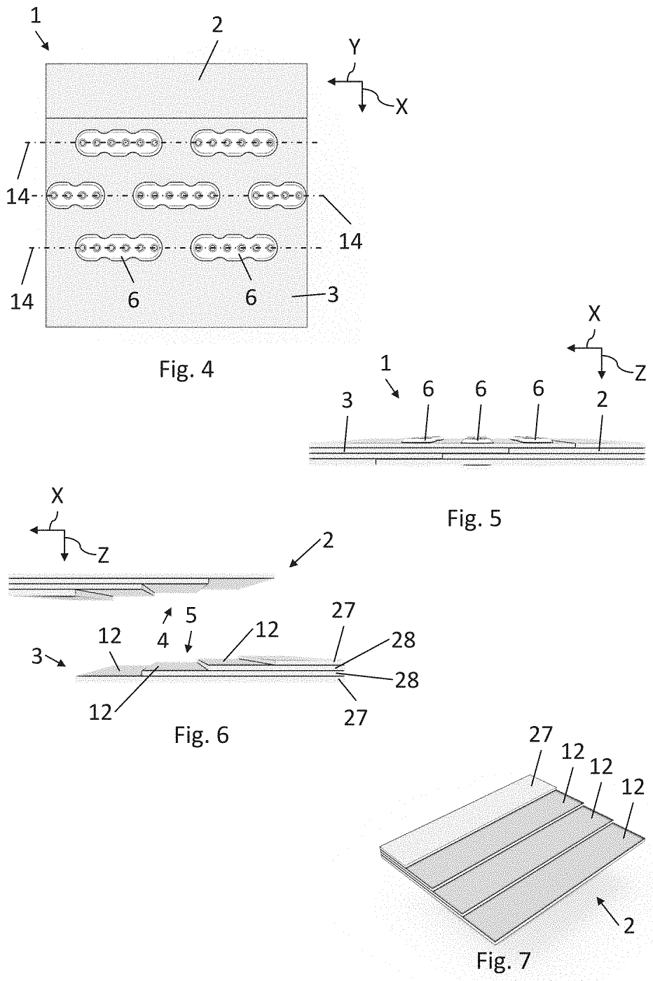

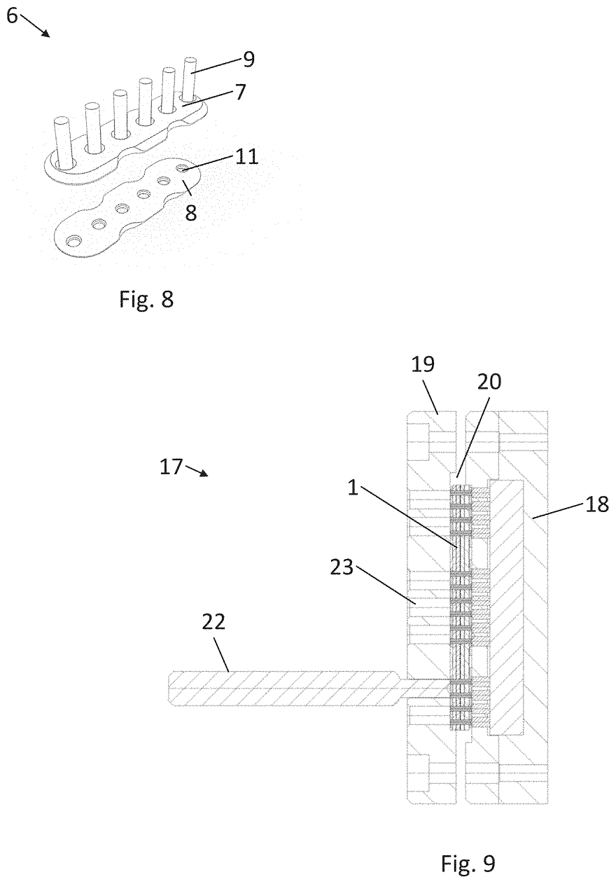

The longitudinal direction of the belt 1 runs in the direction of travel of the belt 1, in the present case in the X-direction. The transverse direction of the belt 1 runs in the Y-direction. The thickness of the belt 1 corresponds to the extent thereof in the Z-direction. The width of the belt 1 corresponds to the extent thereof in the Y-direction. (See FIGS. 3-6).

A first end 2 of the two ends 2, 3 has a first connecting portion 4 (FIG. 6) which in the present case is of stepped configuration. A second end 3 of the two ends 2, 3 has a second stepped connecting portion 5 (FIG. 6) corresponding to the first connecting portion 4. The stepped connecting portions 4, 5 in the present case are designed such that in each case the textile layer 12 is exposed. The two connecting portions 4, 5 are arranged so as to overlap in an overlapping region in the Z-direction, so that the textile layer 12 bears against the textile layer 12, as is revealed in particular in FIGS. 5 and 6. A plurality of connectors 6 are arranged in the overlapping region, wherein in the present case the connection has three rows 14 of connectors 6, wherein the rows 14 in the present case run in parallel and in the transverse direction of the belt 1. Abutting ends of the connecting portions 4, 5 are configured in the present case with an angle of inclination of 0°. The abutting ends thus run in the Y-direction.

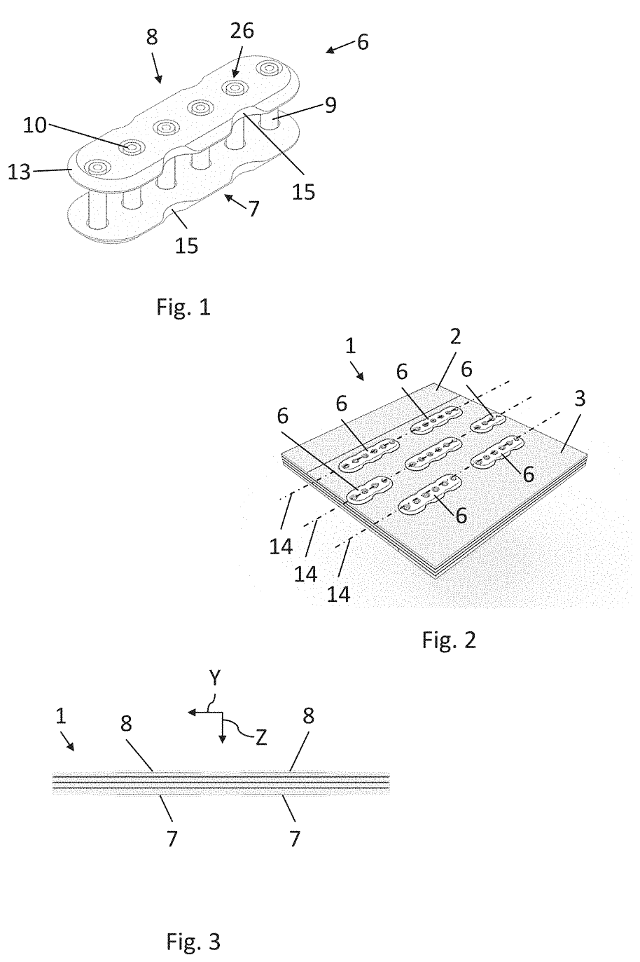

The respective connector 6 penetrates, with the connecting means 9 (FIG. 1), the first connecting portion 4 and the second connecting portion 5. The respective connector 6 has a first plate-shaped base body portion 7 and a second plate-shaped base body portion 8. The two connecting portions 4, 5 are arranged between the two base body portions 7, 8, wherein the respective first base body portion 7 bears against the first outer top layer 27 of the belt 1 and the second base body portion 8 against the second outer top layer 27.

The connecting means 9 are held in the first and the second base body portions 7, 8, wherein for the purpose of holding the connecting means 9 in the respective base body portion 7, 8 the respective connecting means 9 has a closing head 10 configured by a material deformation. FIG. 8 shows the connecting means 9 in a state before forming the closing head 10. FIG. 1 shows the connecting means 9 after forming the closing head 10.

The respective connector 6 has in the present case a single row of connecting means 9, wherein the connecting means 9 are arranged along a straight line, namely along a straight line running in the longitudinal direction of the respective connector 6.

In the present case, the connecting means 9 are configured in the manner of a stud pin, wherein the stud pin is configured as a solid cylinder with a circular bottom surface.

In the present case, the respective base body portion 7, 8, has a material thickness of 1.5 mm. The base body portions shown in FIG. 1 have a longitudinal extent of approximately 10 cm. In the present case, the respective stud pin has a diameter of 2 mm and a length of 3 cm.

On the end side the connecting means 9 may be deformed, for example by means of a expanding mandrel, for the purpose of forming the closing head 10 with a diameter widening relative to the region of the connecting means 9 which is adjacent in the axial direction. For example, the closing head 10 has a diameter of 2.4 mm in the case of a stud pin with a 2 mm diameter.

For the purpose of receiving the closing head 10 the respective base body portion 7, 8 has a recess 26. The recess 26 has a depth of approximately 0.2 mm.

As may be derived in particular from FIG. 1, the respective base body portion 7, 8 has a peripheral chamfered lead-in edge 13. This lead-in edge 13 facilitates, for example, contact with a pulley for the belt 1 without causing damage.

Moreover, the respective base body portion 7, 8 has a plurality of opposing indentations 15 in the region of the peripheral lead-in edge 13.

FIG. 8 shows a connector 6 according to the invention before the introduction thereof into the connecting portions 4, 5 of the belt 1. The base body portion 7 has bearing openings, wherein the respective connecting means 9 is mounted non-positively in one of the bearing openings. The connecting means 9 in this case are arranged so as to protrude on a side of the base body portion 7 remote from the second base body portion 8. The second base body portion 8 has receiving openings 11 for receiving the connecting means 9. Preferably, the receiving opening 11 widens in the direction of the first base body portion 7, in particular widens conically.

For the purpose of producing the connection between the two base body portions 7, 8 by means of the connecting means 9, the connecting means 9 are driven in the direction of the second base body portion 8 through the first base body portion 7. In the arrangement shown in FIG. 8, for the purpose of producing the connection according to the invention, the two overlapping connecting portions 4, 5 of the belt 1 would have to be arranged in the free intermediate region between the two base body portions 7, 8 and then the connecting means 9 would have to be driven in the direction of the second base body portion 8 through the two connecting portions 4, 5 and the connecting means 9 would have to be deformed on the end side for the purpose of forming the closing head 10.

The production of the connection advantageously takes place with the device 17 shown in FIG. 9. To this end, the device 17 has two clamping jaws 18, 19 which are movable relative to one another. A receiving region 20 for the clamped receiving of the connecting portions 4, 5 in the overlapping region of the connecting portions 4, 5 and the connectors 6 is configured between the two clamping jaws 18, 19.

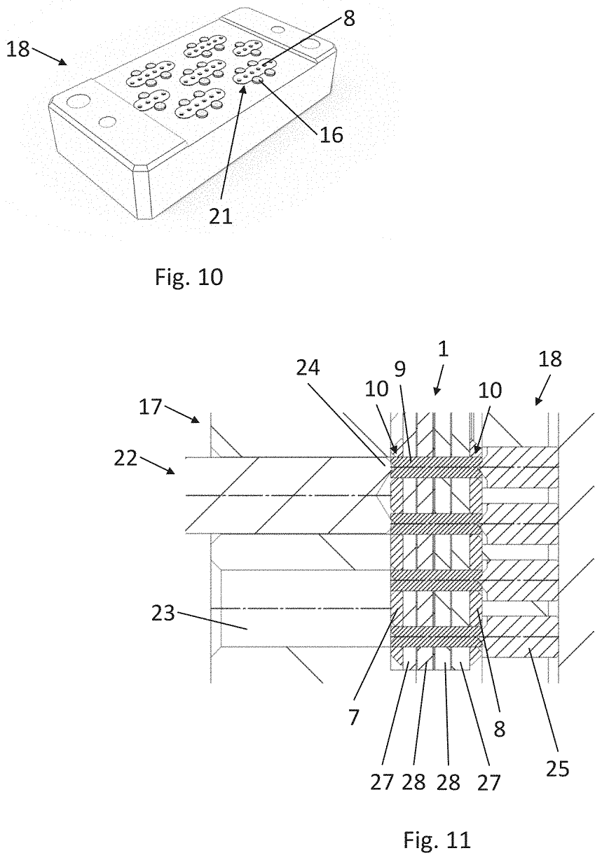

A first clamping jaw 18 of the two clamping jaws 18, 19 has a plurality of bearing structures 21 (FIG. 10), in the present case seven, for bearing the second base body portions 8 of the connectors 6. The respective bearing structure 21 has a plurality of opposing bearing means 16 (FIG. 10) which correspond to the indentations 15 of the base body portions 7, 8.

The device 17 also has a deformation tool 22 for deforming an end of the connecting means 9 for the purpose of forming the closing head 10. A second clamping jaw 19 of the two clamping jaws 18, 19 has a plurality of guide structures 23 penetrating the clamping jaw 19 and formed by a through-opening with a circular cross section, wherein the respective guide structure 23 serves for the axial guidance of the deformation tool 22. The deformation tool 22 has on the end side a peripheral projection 24 (FIG. 11) protruding in the axial direction, wherein the respective guide structure 23 is configured to receive two adjacent connecting means 9 of a connector 6, such that when arranging the deformation tool 22 in the respective guide structure 23 and with the axial displacement of the deformation tool 22 relative to the guide structure 23 in the direction of the first clamping jaw 18, the peripheral projection 24 comes into contact with the two connecting means 9 on the end side. With such a design it is possible in a particularly simple manner by means of the deformation tool 22 to drive two connecting means 9 at the same time into the connecting portions 4, 5 of the belt ends 2, 3 and to produce the respective closing head 10. Preferably, before being driven in and/or when being driven in, the two connecting means 9 are in contact with a wall circulating around the through-opening in a peripheral manner. The driving-in and deformation of the connecting means 9 by means of the deformation tool 22 preferably takes place by hand, in particular by using a hammer.

In order to simplify further the production of the connection, the device 17 has a plurality of deformation structures 25 (FIG. 11) which are fixedly mounted in the first clamping jaw 18 and which serve for deforming the end of the respective connecting means 9 remote from the deformation tool 22, for the purpose of producing the closing head 10. The deformation structure 25 is configured in the manner of a mandrel. In such a design, when driving in the connecting means 9 the two opposing closing heads 10 are configured in one step on the respective connecting means 9.

After driving in the connecting means 9 arranged in the respective guide structure 23, the deformation tool 22 may be introduced into one of the remaining guide structures 23 and the connecting means 9 which are located there are driven in until all of the connecting means 9 are driven in.

The opposing closing heads 10 of the connecting means 9 are configured differently due to the different design of the structures 24, 25 acting on the end side, namely as a deformation structure 25 configured as a mandrel and peripheral projection 24. Whilst a closing head 10 with a central depression and a radial projection enclosing the depression in a peripheral manner is formed by the action of the mandrel, on the remote side a closing head 10 is formed with a circular arc-shaped depression and substantially circular arc-shaped radial projections adjoining the circular arc-shaped depression on both sides.

That which is claimed is:

1. A connection of two ends of a belt or one end of a belt and one end of a further belt, wherein a first end of the two ends has a stepped and/or wedge-shaped first connecting portion and a second end of the two ends has a stepped and/or wedge-shaped second connecting portion corresponding to the first connecting portion, wherein the first and second connecting portions are arranged so as to overlap in an overlapping region, wherein a plurality of connectors are arranged in the overlapping region, wherein each connector penetrates the first connecting portion and the second connecting portion, wherein each connector has a first base body portion and a second base body portion, wherein the first and second connecting portions are arranged between the first and second base body portions, wherein each connector has at least two connecting means, wherein the at least two connecting means are held in the first and second base body portions and penetrate the first and second connecting portions.

2. The connection according to claim 1, wherein the connecting means is positively held in at least one of the first and second base body portions.

3. The connection according to claim 2, wherein the connecting means is held by a material deformation of the connecting means in at least one of the first and second base body portions, and wherein the connecting means is configured as a rivet or stud pin.

4. The connection according to claim 1, wherein the connecting means has a thread and at least one of the first and second base body portions has a counter thread corresponding to the thread, and wherein the connecting means is screwed into the counter thread of the base body portion.

5. The connection according to claim 1, wherein the belt has a plurality of layers, and wherein the belt has at least one intermediate layer.

6. The connection according to claim 1, wherein a material connection is not present in the overlapping region between the first and second connecting portions.

7. The connection according to claim 1, wherein the connection has at least two rows of connectors, and wherein each row has at least two connectors.

8. The connection according to claim 1, wherein at least one of the first and second base body portions in the region of a peripheral edge has at least two indentations for receiving bearing means for bearing the at least one of the first and second base body portions.

9. The connection according to claim 1, wherein the first and second base body portions are of plate-shaped configuration and at least one of the first and second base body portions has a lead-in edge.

10. The connection according to claim 1, wherein the connecting means has a closing head, and wherein at least one of the first and second base body portions has a recess for receiving the closing head.

11. A connector for producing a connection according to claim 1.

12. A connector having a first base body portion and a second base body portion, wherein a first connecting portion of an end of a belt and a second connecting portion of an end of a belt are arranged to overlap between the first and second base body portions, wherein the connector has at least two connecting means, wherein the at least two connecting means are mounted in the first base body portion, wherein the connecting means are configured to be connected to the second base body portion by penetrating the first and second connecting portions arranged between the first and second base body portions, wherein the first base body portion has bearing openings, and wherein each connecting means is non-positively mounted in one of the bearing openings.

13. The connector according to claim 12, wherein the second base body portion has receiving openings for receiving the connecting means, and wherein each receiving opening widens in the direction of the first base body portion.

14. The connector according to claim 12, wherein the first base body portion and the second base body portion are configured identically.

15. A device for producing a connection according to claim 1, wherein the device has two clamping jaws which are movable relative to one another, wherein a receiving region is configured between the clamping jaws for the clamped receiving of the first and second connecting portions in the overlapping region of the first and second connecting portions, wherein a first clamping jaw of the two clamping jaws has bearing structures for bearing the second base body portions, wherein the device has a deformation tool for deforming an end of the connecting means, wherein a second clamping jaw of the two clamping jaws has at least one guide structure penetrating the second clamping jaw for axially guiding the deformation tool, and wherein the deformation tool has on an end side a peripheral projection protruding in the axial direction, wherein the guide structure is configured to receive two adjacent connecting means of a connector such that with an axial displacement of the deformation tool in the direction of the first clamping jaw the deformation tool comes into contact with the two connecting means on the end side.
